(19) United States
(12) Patent Application Publication
(10) Pub. No.: US 2021/0287294 A1
(43) Pub. Date: Sep. 16, 2021

(54) TAX LIABILITY FREE SAVINGS METHOD

(71) Applicant: Carlton P. Johnson, Lakewood, CO (US)

(72) Inventor: Carlton P. Johnson, Lakewood, CO (US)

(21) Appl. No.: 16/814,682

(22) Filed: Mar. 10, 2020

(51) Int. Cl. G06Q 40/06; G06Q 50/26; G06Q 40/00; G06Q 10/10

(52) U.S. Cl. CPC G06Q 40/06; G06Q 50/265; G06Q 10/1057; G06Q 10/1053; G06Q 40/10

(57) ABSTRACT

The present invention provides a tax free financial planning method for a child. In particular, the method of the invention includes earning an income by the child without any tax liability, saving the earned income and having the income grow without any tax liability, and withdrawing the savings, all without any tax liability.

### FIELD OF THE INVENTION

The present invention relates to a method for a child to earn income, save the earned income, and withdrawal the savings, without any tax liability.

### BACKGROUND OF THE INVENTION

Many parents or guardians of a child provide financial assistance and/or financial planning for their child. Typically, parents provide savings for their child under Uniform Gifts to Minors Act (UGMA), Uniform Transfers to Minors Act (UTMA) or under 529 savings plan, thereby avoiding at least a portion of tax liability on the amount of funds.

Under the U.S. tax saving codes, one can either avoid tax on earning (e.g., individual retirement account or IRA) or when the fund is distributed or withdrawn under certain circumstances that meet no tax liability requirements (e.g., Roth IRA). Thus, most tax saving financial planning services are based either on avoiding paying tax on earnings, avoiding paying tax on distribution, and the annual growth of investment.

### SUMMARY OF THE INVENTION

The savings methods of the present invention avoid any tax liability including on earned income, growth, as well as during distribution of funds. In particular, the savings methods of the invention allow a child to earn income without paying any taxes, growth over the years, and allow that earned income to be distributed without any tax liability.

Methods of the invention also allows funds to be used for the child's college expenses, first time home buying, medical expenses, and other eligible child expenses without any tax liability prior to the child reaching the age of retirement.

Methods of the invention provides a significant savings to the child never before seen in any investments, 529, life insurance, stocks, Gifting to Minor Act, allowance, etc. More significantly, methods of the invention have never been marketed by any bank, investment companies, insurance firms, or any financial industry companies.

### DETAILED DESCRIPTION OF THE INVENTION

Methods of the invention provide a child wealth-building savings plan. In particular, methods of the present invention allow a child to earn income tax free, having the income earn interest, growth, dividends, tax free, and use of the funds without any tax liability. In this manner, all of the earnings and any interest earned by the child is free of any tax liability.

One particular aspect of the invention provides a savings method for a child without having to pay any tax, said method comprising:
said child rendering a service to said child's parent, wherein said child is within the age promulgated by the U.S. tax code to be exempt from paying social security and medicare taxes for earned income;
said child receiving a payment from said child's parent directly for the service rendered, wherein the total income earned by said child from said child's parent in a taxable fiscal year is below the standard deduction amount promulgated by the U.S. tax code;
said child placing the total income earned in said child's Roth IRA; and
said child withdrawing funds from said child's Roth IRA during a tax and penalty-free period or for tax and penalty-free exception use as promulgated by the U.S. tax code,
   thereby allowing said child to avoid any tax liability for said earned income, for said withdrawn fund, and any interests and dividends.

In some embodiments, said payment to said child for the service is tax deductible to said parent.

Another aspect of the invention provides a method for a parent to provide a tax free savings for said parent's child, said method comprising:
employing said child for a service, wherein said child is within the age promulgated by the U.S. tax code to be exempt from paying social security and medicare taxes for earned income;
paying wage to said child for the service rendered directly by said parent;
having said child deposit the wage to said child's Roth IRA account; and
said child withdrawing funds from said child's Roth IRA during a tax and penalty-free period or for tax and penalty-free exception use as promulgated by the U.S. tax code,
   thereby allowing said child to avoid any tax liability for said earned income and for said withdrawn funds.

In some embodiments, said wage is tax deductible to said parent.

Embodiments are described more fully below in sufficient detail to enable those skilled in the art to practice the system and method. However, embodiments can be implemented in many different forms and should not be construed as being limited to the embodiments set forth herein. The following detailed description is, therefore, not to be taken in a limiting sense.

The present invention generally provides a child wealth-building method. Generally, the method of the invention includes hiring or engaging a child by the parent for services, paying the child for services rendered, and having the child deposit the earning to child's Roth IRA. In particular, the child should be within the age promulgated by the U.S. tax code to be exempt from paying social security and medicare taxes for earned income. It should be noted that the wage payment is made by the parent as an individual not as a company, corporation, or other legal entity. Thus, even if the parent hires or engages the child for services for the parent's company work, the wage must be paid directly by the parent, i.e., as an individual. The wages paid should be eligible for a contribution to a Roth Individual Retirement Account (“Roth IRA”).

Under standard current Internal Revenue Service (IRS) rules and regulations, a parent is allowed to pay a child wages as income from the ages of 14 to 21 for services performed for the benefit of the employer (parent). Neither the parent nor the child are required to pay any Social Security or Medicare or matching Social Security and Medicare taxes on the child's wages, up to age 18 and no FUTA (Federal Unemployment Tax Act) tax under the age of 21. Furthermore, the child does not need to pay self-employment taxes (i.e., self employed Social Security and Medicare taxes). Wages from a parent to a child under the age of 18 are also exempt from FICA tax (Social Security and Medicare tax). This is a significant tax savings on each dollar earned by the child from the parents, from ages 14-18. Parents and child will pay additional Social Security and Medicare taxes from ages 18-21.

In one embodiment of the invention, the parent employs and pays the child for the maximum amount allowed for contribution to the Roth IRA each year on an individual basis for actual services rendered. These wages may or may not be tax deductible for the parent, depending on deductibility of the services rendered by the child as described by the Tax Code. This depends on the individual circumstances of each particular situation. For example, childcare paid to an older child for supervising a younger child is tax deductible if both parents work. In contrast, cleaning of a child's personal room for excessive wages is one example of an expense that is not tax deductible. Depending on the situation, the wage payment to the child may or may not be tax deductible for the parents, but in many instances, is deductible on the parent's 1040 individual income tax return through the Schedule A, C, F, 2441 or other legal wage reporting schedules. The present invention is designed for a specific purpose of building child's wealth. Some examples of possibly tax-deductible wages to a child are provided herein.

Typically, a child may be paid for any services that a parent would normally pay to unrelated third parties. Some examples of third party expenses that may be tax deductible to the parent are: childcare (e.g., for child's siblings); housekeeping; landscaping (i.e., yard work); painting; running errands for small business; detailing out medical and dental expenses; bookkeeping; spread sheeting and detailing cash and non cash contributions; providing banking and/or input checks to spreadsheet or financial program; assisting on rental properties (i.e., making collection calls, cleaning rental properties after vacancies and repairs); assisting with spread sheeting and keeping track of parental employee business expenses; farming/field work on a farm; animal husbandry; driving of farm equipment; framing, roofing services and other handyman type of work; personal care services; laundry services for small business; banking/investing services; handling advertising budget for small business on Schedule C, E, or F.

In some embodiments, the child receives an amount of wage income each year and claims this income on his or her federal (and state) income tax return, if applicable. In some cases, when there is no other income, there may be no tax return required at all (i.e., any earned income below $5700 is not taxable). In other cases, the child would be required to pay appropriate federal and state income tax on all income, but still not be required to pay Social Security and Medicare tax or self-employment tax on the income for services provided to the parents. In the year 2011, the IRS does not require a child to file a tax return if earned income is below $5700. If this is the only source of income, the $5000 payment for services/Roth contribution would be entirely tax-free to the child on the federal level and state income tax level.

The full amount of annually allowed Roth IRA contribution of wage income, rather than being paid as cash directly to the child, may be deposited into the child's Roth IRA for the full 8 years (age 14 to 21). This provides a maximum investment amount for the child in tax free savings. This maximum investment helps build the child's wealth and provides financial training learning skills, job talent, work habits, and other excellent traits to the job market from parents to the child. If this is child's only source of income, no tax is paid on this money. This child's Roth IRA investment grows tax free in the Roth environment until the child reaches retirement age. The wages go in tax free, the investment grows tax free and at retirement, the child can withdraw the money tax free.

As can be seen, methods of the invention goes against the current major push of giving children money for college education and builds for the child a source of wealth and a family retirement that most people do not expect and as of today, have never heard of. It is understood that unlike traditional savings accounts, such as UTMA and UGMA, college financial offices cannot use this money to negatively impact the child's application for financial aid, because it is considered not accessible by the child until retirement age. In addition to protection from colleges, it is understood that this Roth retirement account is protected from bankruptcies, collections or other third parties who might otherwise pursue the child's other assets from age 18 through the rest of their life to retirement. This is a great tool for wealth building.

The strategy of the present invention allows parents to use the Roth IRA vehicle to put money away for a child. For those attempting to build the wealth of a child, many people know and use the current gift laws. The maximum amount allowed (e.g., under UGMA or UTMA) is not tax deductible to the parents and not taxable to the child. In certain cases, methods of the present invention provide tax deduction to the parent and non-taxable savings to the child. This obviously makes more sense because the parent is in a higher tax bracket than the child and the child usually will not pay income tax on these wages. The child's payment for services would go immediately into the child's Roth IRA, for retirement growth.

Methods of the invention provide allocation of wages of a child for retirement rather than gifting money through the teen and early twenties, which they will undoubtedly spend.

As the child takes the money out at retirement, it is not taxable, which is a tremendous savings to the child. In fact, this portion of the funds would entirely tax-free (going in, growing and coming out).

This is a substantial family/estate-planning tool as the child's wages contributed each year, e.g., for 8 years, into the child's Roth IRA to grow tax-free until retirement age or is withdrawn under tax free conditions allowed by the U.S. tax code.

To avoid having any tax liability, the child withdraws the funds in this Roth IRA during a tax and penalty-free period or for tax and penalty-free exception use as promulgated by the U.S. tax code. It is believed that this strategy has never been discussed as an option as an estate and retirement planning tool. This method has never been produced at banks, insurance companies, financial institutions or financial planning offices. This method, or strategy, has not yet been identified and defined by anyone else.

It should be appreciated that methods disclosed herein can be computer-implemented or be made available via a computer readable medium.

What is claimed is:

1. A savings method for a child without having to pay any tax during depositing, income growth, or withdrawal, said method comprising:
said child rendering a service to said child's parent, wherein said child is within the age promulgated by the U.S. tax code to be exempt from paying social security and medicare taxes for earned income;
said child receiving a payment from said child's parent directly for the service rendered, wherein the total income earned by said child from said child's parent in a taxable fiscal year is below the standard deduction amount promulgated by the U.S. tax code;
said child placing the total income earned in said child's Roth IRA; and
said child withdrawing funds from said child's Roth IRA during a tax and penalty-free period or for tax and penalty-free exception use as promulgated by the U.S. tax code,
thereby allowing said child to avoid any tax liability for said earned income, income growth, and for said withdrawn fund.

2. The savings method of claim 1, wherein said payment to said child for the service is tax deductible to said parent but is not taxable to said child.

3. A method for a parent to provide a tax free savings for said parent's child, said method comprising:
employing said child for a service, wherein said child is within the age promulgated by the U.S. tax code to be exempt from paying social security and medicare taxes for earned income;
paying wage to said child for the service rendered directly by said parent;
having said child deposit the wage to said child's Roth IRA account; and
said child withdrawing funds from said child's Roth IRA during a tax and penalty-free period or for tax and penalty-free exception use as promulgated by the U.S. tax code,
thereby allowing said child to avoid any tax liability for said earned income and for said withdrawn fund.

4. The method of claim 3, wherein said wage is tax deductible to said parent.
